(19) United States
(12) Patent Application Publication
(10) Pub. No.: US 2020/0078136 A1
(43) Pub. Date: Mar. 12, 2020

(54) ENDODONTIC OBTURATOR FOR BIOACTIVE MATERIAL DELIVERY

(71) Applicant: KING SAUD UNIVERSITY, Riyadh (SA)

(72) Inventors: MOHAMMAD AHMAD ALENEZI, KUWAIT CITY (KW); MOHAMMAD IBRAHIM ALOBAIDA, RIYADH (SA)

(21) Appl. No.: 16/123,187

(22) Filed: Sep. 6, 2018

(51) Int. Cl. A61C 5/50; A61C 5/40; A61C 19/06

(52) U.S. Cl. CPC A61C 5/50; A61C 2201/007; A61C 19/06; A61C 5/40

(57) ABSTRACT

The endodontic obturator for bioactive material delivery includes a shaft having opposed tip and shank ends, and a fluted portion located adjacent the tip end and having at least one flute spiraling along an axial length thereof. As a non-limiting example, the shaft may be formed from a nickel-titanium alloy coated with polytetrafluoroethylene. The forward portion is tapered toward the tip end, and the tip end is flat, with a fan-like cross-section, defining a plurality of radial lands. As a non-limiting example, three radial lands, each with a neutral rake angle, may be defined on the tip end.

### BACKGROUND

### 1. Field

The disclosure of the present patent application relates to dental instruments, and particularly to an endodontic obturator for use in filling an endodontically prepared root canal with a bioactive material.

### 2. Description of the Related Art

Endodontic therapy (also known as “endodontic treatment” or “root canal therapy”) is a treatment sequence for the infected pulp of a tooth, which results in the elimination of infection and the protection of the decontaminated tooth from future microbial invasion. Root canals, and their associated pulp chamber, are the physical hollows within a tooth that are naturally inhabited by nerve tissue, blood vessels and other cellular entities. Together, these items constitute the dental pulp. Endodontic therapy involves the removal of these structures, the subsequent shaping, cleaning, and decontamination of the hollows with small files and irrigating solutions, and the obturation (i.e., filling) of the decontaminated canals. Filling of the cleaned and decontaminated canals is done with an inert filling, such as gutta-percha, and typically a eugenol-based cement.

Despite how common endodontic therapy is, there are numerous risks involved in the procedure. For example, canals may be unusually shaped, making them impossible to clean and fill completely, resulting in infected material remaining in the canal. As another example, the canal filling may not fully extend to the apex of the tooth, or the filling does not fill the canal as densely as it should. A tooth root may also be perforated while the root canal is being treated, making it difficult to fill the tooth. In such cases, the perforation may be filled with a root repair material, such as one derived from natural cement; e.g., mineral trioxide aggregate (MTA). A specialist can often re-treat failing root canals, and these teeth will then heal, often years after the initial root canal procedure.

MTA is only one example of a bioactive endodontic material (BEM). Such materials have become commonplace in endodontic therapy procedures due to their superior physiochemical and bioactive properties. BEMs, being insensitive to fluids, provide an effective seal against dentin and cementum, as well as promoting biological repair and regeneration of the periodontal ligament. As noted above, BEMs may be used in root-end resection as a retrograde filling, often as a form of treatment of procedural errors, as well as for vital pulp therapy and the orthograde filling of the apical region or the entire root canal system. Delivery of these materials to the apical region, however, is challenging, because it requires superior operator skills and very specific tools to perform such procedures.

The use of nickel titanium (NiTi) rotary files in dentistry is a common practice. A nickel titanium rotary file is an engine-driven, tapered and pointed endodontic instrument made of nickel-titanium alloy, which has cutting edges used to mechanically shape and prepare the root canals during endodontic therapy or to remove the root canal obturating material while performing retreatment. Superelasticity and shape memory are the properties that make Niti files very flexible. The high flexibility of Niti files makes them superior to stainless steel files for the purpose of rotary root canal preparation. It would obviously be desirable to be able to combine the usefulness and ease of use of the nickel titanium rotary file with the delivery of bioactive materials during obturation. Thus, an endodontic obturator for bioactive material delivery solving the aforementioned problems is desired.

### SUMMARY

The endodontic obturator for bioactive material delivery includes a shaft having opposed tip and shank ends, with a forward portion of the shaft being located adjacent the tip end and having at least one flute spiraling along an axial length thereof. As a non-limiting example, the shaft may be formed from a nickel-titanium alloy coated with polytetrafluorocthylene, which prevents adhesion between bioactive endodontic material and the instrument. The forward portion is tapered toward the tip end, and the tip end is flattened with a fan-like cross-section, defining a plurality of radial lands. As a non-limiting example, three radial lands, each with a neutral rake angle, may be defined on the tip end.

The endodontic obturator for bioactive material delivery is used in a manner similar to a conventional obturator. The shank end of the endodontic obturator for bioactive material delivery is connected to a conventional endodontic rotary motor handpiece, with a speed set to approximately 150 rpm and driven counterclockwise. As in a conventional procedure, the working length of the root canal is determined and the bioactive materials are applied with an amalgam carrier into the instrumented root canal orifice. The endodontic obturator for bioactive material delivery is then placed in the root canal, 3-4 mm short of the original working length, and the endodontic obturator for bioactive material delivery is used to deposit and pack the bioactive endodontic materials into the intended part of the root canal system. The counterclockwise motion and the design of the flutes, as described above, allows for dislodging of the bioactive endodontic materials from the sides of the root canal into the apical area, guaranteeing clean root canal walls. The neutral rake angles of the lands prevent any undesired dentin cutting during placement of the bioactive endodontic materials.

These and other features of the present disclosure will become readily apparent upon further review of the following specification and drawings.

### BRIEF DESCRIPTION OF THE DRAWINGS

FIG. 1 is a perspective view of an endodontic obturator for bioactive material delivery.

FIG. 2 is a bottom view of the endodontic obturator for bioactive material delivery.

Similar reference characters denote corresponding features consistently throughout the attached drawings.

### DETAILED DESCRIPTION OF THE PREFERRED EMBODIMENTS

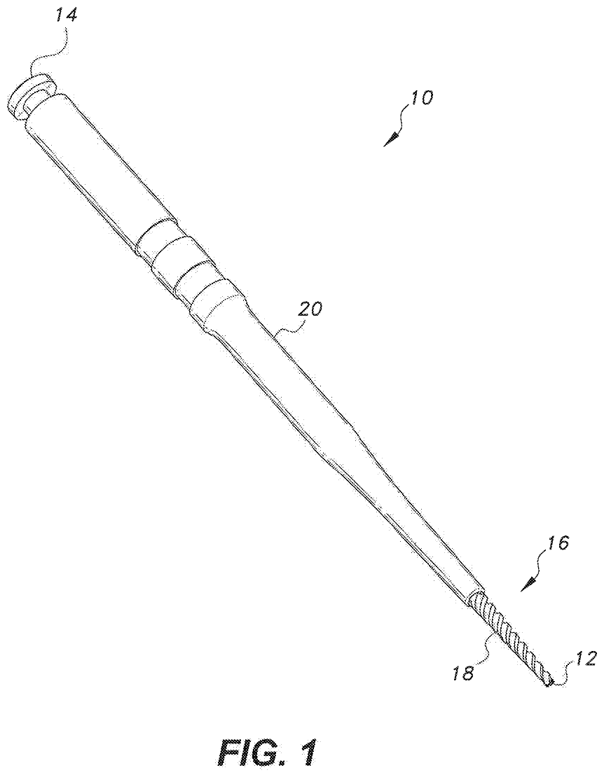

Referring now to FIG. 1, the endodontic obturator for bioactive material delivery 10 includes a shaft 20 having opposed tip and shank ends, 12, 14, respectively, with a fluted portion 16 of shaft 20 being located adjacent the tip end 12 and having at least one flute 18, spiraling along an axial length thereof. For example, approximately four or more flutes may be defined on fluted portion 16. As a non-limiting example, the shaft 20 may be formed from a nickel-titanium alloy coated with polytetrafluoroethylene.

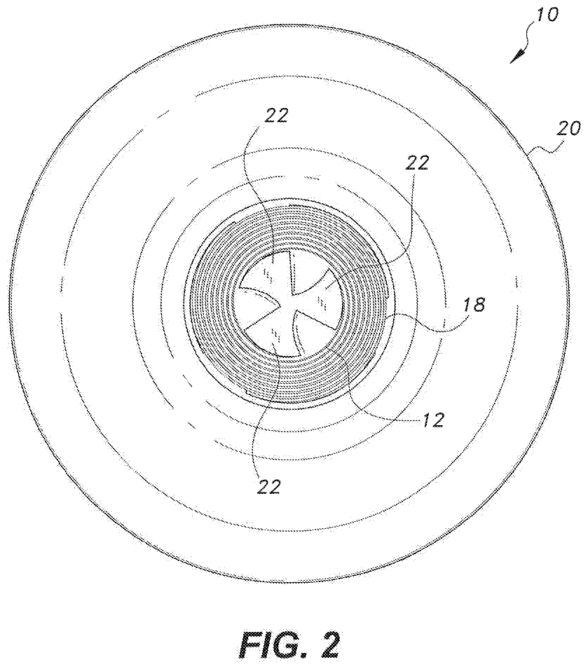

As shown, the fluted portion 16 is tapered toward the tip end 12. As a non-limiting example, the tapering of fluted portion 16 may cover a 6% decrease in diameter toward tip end 12. As best shown in FIG. 2, the tip end 12 is flat, with a fan-like cross-section, defining a plurality of radial lands 22. As a non-limiting example, three radial lands 22, each with a neutral rake angle, may be defined on the tip end 12, as shown in the example of FIG. 2.

Although it should be understood that the endodontic obturator for bioactive material delivery 10 may be constructed with any desired relative dimensions, an exemplary overall axial length for the endodontic obturator for bioactive material delivery 10 may be approximately 22 mm. In this example, the flat, non-cutting tip end 12 may have a diameter of approximately 0.6 mm, and fluted portion 16 may have an axial length of approximately 6.0 mm.

The endodontic obturator for bioactive material delivery 10 is used in a manner similar to a conventional obturator. The shank end 14 of the endodontic obturator for bioactive material delivery 10 is connected to a conventional endodontic rotary motor handpiece, as is conventionally known, with a speed set to approximately 150 rpm and a torque setting of approximately 0.0 Nem, and driven counterclockwise. As in a conventional procedure, the working length of the root canal is determined and the bioactive materials are applied with an amalgam carrier into the instrumented root canal orifice. The endodontic obturator for bioactive material delivery 10 is then placed in the root canal, 3-4 mm short of the original working length, and the endodontic obturator for bioactive material delivery 10 is used to deposit and pack the bioactive endodontic materials into the intended part of the root canal system. The counterclockwise motion and the design of the flutes 18, as described above, allow for dislodging of the bioactive endodontic materials from the sides of the root canal into the apical area, guaranteeing clean root canal walls. The neutral rake angles of the lands 22 prevent any undesired dentin cutting during placement of the bioactive endodontic materials.

It is to be understood that the endodontic obturator for bioactive material delivery is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. An endodontic obturator for bioactive material delivery, comprising:
a shaft having opposed tip and shank ends; and
a fluted portion adjacent the tip end, the fluted portion being spaced from the shank end and having a length of 6.0 mm, the fluted portion further having a plurality of helical-shaped flutes spiraling along an axial length thereof to the tip end, the helical-shaped flutes being configured to accommodate counterclockwise motion, the fluted portion having a 6% decreasing taper toward the tip end, the tip end including a plurality of flat radial lands thereby defining a flat, non-cutting tip end.

2. The endodontic obturator for bioactive material delivery as recited in claim 1, wherein the shaft comprises a nickel-titanium alloy coated with polytetrafluoroethylene.

3. The endodontic obturator for bioactive material delivery as recited in claim 1, wherein the plurality of flat radial lands comprises three radial lands.

4. (canceled)

5. The endodontic obturator for bioactive material delivery as recited in claim 1, wherein:
a length of the shaft is approximately 22 mm; and
a diameter of the tip end is approximately 0.6 mm.

6-8. (canceled)
